(19) United States
(12) Patent Application Publication
(10) Pub. No.: US 2016/0298777 A1
(43) Pub. Date: Oct. 13, 2016

(54) SELF REGULATING PRESSURE THROTTLE

(71) Applicant: Eaton Corporation, Cleveland, OH (US)

(72) Inventors: Mustafa Huseyin, Karlsruhe (DE); Stefan Walter, Stutensee (DE)

(21) Appl. No.: 15/184,628

(22) Filed: Jun. 16, 2016

Related U.S. Application Data
(63) Continuation of application No. PCT/US2014/071151, filed on Dec. 18, 2014.
(60) Provisional application No. 61/918,343, filed on Dec. 19, 2013.

(51) Int. Cl. F16K 17/34; G05D 7/01; F16K 17/30

(52) U.S. Cl. CPC F16K 17/34; F16K 17/30; G05D 7/012; F02M 25/0836

(57) ABSTRACT

A self-regulating pressure throttle configured for use in a fluid conduit includes a throttle body having a series of segments. The throttle body includes an inlet end and an outlet end. The throttle body includes a cone portion and a rim portion. The cone portion tapers away from the rim portion from a first end to a second end. The second end includes a nozzle orifice. The series of segments can be formed on the cone portion. The series of segments are configured to move between (i) a first position wherein the nozzle orifice has a first diameter and (ii) a second position wherein the nozzle orifice has a second diameter. The second diameter is smaller than the first diameter. The series of segments can be configured to move from the first position to the second position upon an increased pressure flow of fluid at the inlet end.

### CROSS-REFERENCE TO RELATED APPLICATIONS

This application is a continuation of PCT Application No. PCT/US2014/071151 filed on Dec. 18, 2014, which claims the benefit of U.S. Patent Application No. 61/918,343 filed on Dec. 19, 2013. The disclosures of the above applications are incorporated herein by reference.

### FIELD

The present disclosure relates generally to fuel systems on passenger vehicles and more particularly to a throttle that regulates pressure flow.

### BACKGROUND

Proper venting and handling of fuel and fuel vapor is required for fuel systems in passenger vehicles. More particularly, fuel systems must be properly vented and properly account for containment and delivery of liquid fuel for passenger motor vehicles. It is desirable to maintain a proper fluid pressure throughout the fuel system. In some examples it is desirable to maintain a proper fluid pressure of fuel delivered throughout the fuel system. In other configurations it may be desirable to maintain proper fluid pressure of other fluids related to a fuel system. Other fluids include, but are not limited to reductant used in selective catalytic reduction (SCR) systems used in compression-ignition engines to reduce nitrogen oxides in the exhaust stream.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

The present disclosure will become more fully understood from the detailed description and the accompanying drawings, wherein:

FIG. 1 is front perspective view of a self-regulating pressure throttle constructed in accordance to one example of the present disclosure and shown in a first low pressure flow position;

FIG. 2 is a side view of the self-regulating pressure throttle of FIG. 1;

FIG. 3 is a top view of the self-regulating pressure throttle of FIG. 1;

FIG. 4 is a perspective view of the self-regulating pressure throttle of FIG. 1 and shown in a second high pressure flow position;

FIG. 5 is a side view of the self-regulating pressure throttle of FIG. 3;

FIG. 6 is a top view of the self-regulating pressure throttle of FIG. 4;

FIG. 7 is a side view of the self-regulating pressure throttle of FIG. 1 shown disposed in a fluid conduit and in the first low pressure flow position;

FIG. 8 is a side view of the self-regulating pressure throttle of FIG. 7 shown disposed in the fluid conduit and in the second high pressure flow position;

FIG. 9 is a side perspective view of a self-regulating pressure throttle constructed in accordance to additional features of the present disclosure;

FIG. 10 is a side view of the self-regulating pressure throttle of FIG. 9;

FIG. 11 is a top view of a guide cone of the self-regulating pressure throttle of FIG. 9;

FIG. 12 is a top view of a pressure block of the self-regulating pressure throttle of FIG. 9;

FIG. 13 is a side view of the self-regulating pressure throttle of FIG. 9 and shown disposed in a fluid conduit in the first low pressure flow position; and

FIG. 14 is a side view of the self-regulating pressure throttle of FIG. 13 and shown disposed in the fluid conduit and in a second high pressure flow position.

### SUMMARY

A self-regulating pressure throttle configured for use in a fluid conduit according to one example of the present disclosure includes a throttle body having a series of segments. The throttle body includes an inlet end and an outlet end. The throttle body includes a cone portion and a rim portion. The cone portion tapers away from the rim portion from a first end to a second end. The second end includes a nozzle orifice. The series of segments can be formed on the cone portion. The series of segments are configured to move between (i) a first position wherein the nozzle orifice has a first diameter and (ii) a second position wherein the nozzle orifice has a second diameter. The second diameter is smaller than the first diameter. The series of segments can be configured to move from the first position to the second position upon an increased pressure flow of fluid at the inlet end.

According to additional features the series of segments are configured to flex inwardly from the first position to the second position. The cone portion can define a series of slots therein. The series of segments can be formed between adjacent slots of the series of slots. In one configuration, the cone portion includes four segments and four slots. In one example, the throttle body is formed of metal. The rim portion can define a series of apertures therein. Movement of the nozzle orifice from the first diameter to the second diameter can cause a pressure drop of fluid passing through the throttle body to accommodate for an increase of pressure flow of fluid at the inlet end.

A self-regulating pressure throttle configured for use in a fluid conduit and constructed in accordance to additional features of the present disclosure can include a throttle body, a cone portion and series of segments. The throttle body can have an inlet end and an outlet end. The cone portion can be formed on the throttle body and taper away from the rim portion from a first end to a second end. The second end can have a nozzle orifice. The series of segments can be formed on the cone portion. The series of segments can be configured to flex inwardly between (i) a first position wherein the nozzle orifice has a first diameter and (ii) a second position wherein the nozzle orifice has a second diameter. The second diameter is smaller than the first diameter. The series of segments can be configured to move from the first position to the second position upon an increased pressure flow of fluid at the inlet end.

According to other features, the cone portion defines a series of slots therein. The series of segments are formed between adjacent slots of the series of slots. The cone portion can include four segments and four slots. The throttle body can be formed of metal. The rim portion can define a series of apertures therein. Movement of the nozzle orifice from the first diameter to the second diameter can cause a pressure drop of fluid passing through the throttle body to accommodate for an increase of pressure flow of fluid at the inlet end.

A self-regulating throttle configured for use in a fluid conduit and constructed in accordance to other features of the present disclosure can include a guide cone and a pressure block. The guide cone can have an inlet end and an outlet end. The guide cone can include a base portion and a cone portion. The base portion can have a ring that is offset from a central portion by a series of arms. The base portion can define a series of openings. The cone portion can taper away from the base portion to the inlet end. The pressure block can have a block body that defines a block opening. The pressure block can be configured to move relative to the guide cone between (i) a first position wherein fluid flows through the block opening and through the guide cone and (ii) a second position wherein the guide cone locates into the block opening. In the second position, an annular gap is formed between the cone portion and the opening of the pressure block reducing an amount of flow passing through the series of openings in the base portion and the opening of the pressure block.

According to additional features, the self-regulating pressure throttle can further comprise a biasing member disposed between the guide cone and the pressure block. The biasing member can bias the pressure block to the first position. The series of openings are defined by the ring, the central portion and the series of arms. The ring of the base portion can define a series of apertures therein. The block opening can taper from a first end to a second end. The biasing member is compressed when the pressure block is in the second position. The pressure block can be configured to move relative to the guide cone to reduce an area of fluid allowed to flow past the self-regulating pressure throttle.

### DETAILED DESCRIPTION

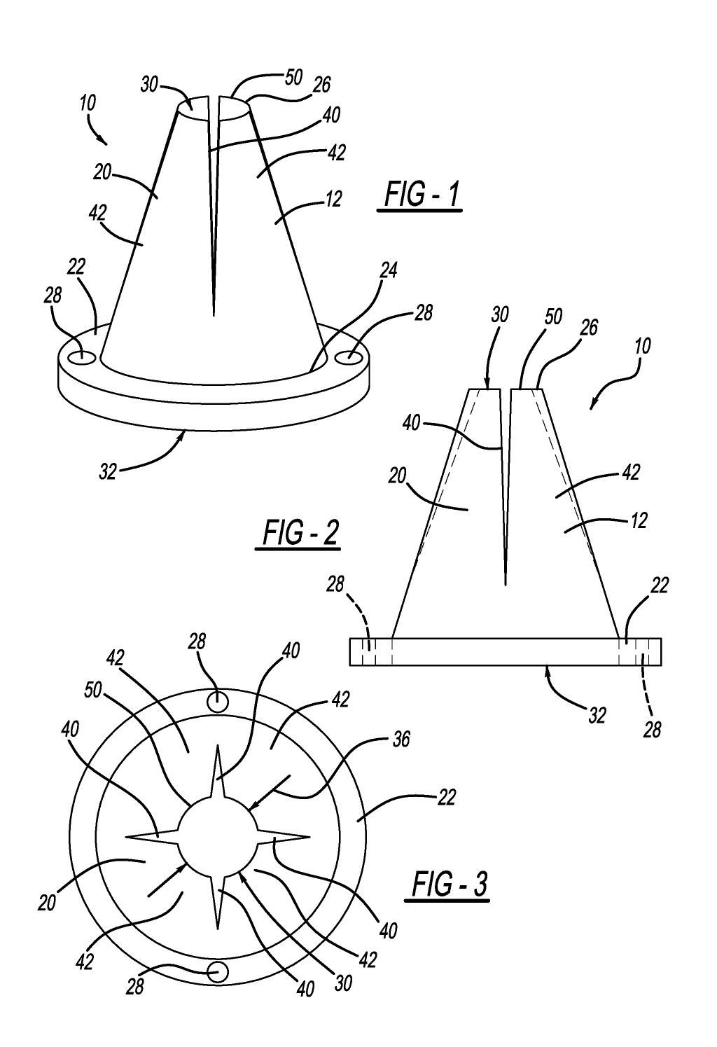

With initial reference to FIGS. 1-8, a self-regulating pressure throttle constructed in accordance to one example of the present disclosure is shown and generally identified at reference numeral 10. The self-regulating pressure throttle 10 can include a throttle body 12 including a cone portion 20 and a rim portion 22. In the example shown, the cone portion 20 can taper away from the rim portion 22 from a first end 24 to a second end 26. A series of apertures 28 can be formed in the rim portion 22. The apertures 28 can be used to attach the self-regulating pressure throttle 10 to another component. The self-regulating pressure throttle 10 can include an inlet end 30 and an outlet end 32. As will be described herein, fluid can enter the self-regulating pressure throttle 10 at the inlet end 30 and exit the self-regulating pressure throttle 10 at the outlet end 32. The self-regulating pressure throttle 10 may be incorporated in any application where it is desirable to regulate a fluid pressure passing through a fluid conduit.

The self-regulating pressure throttle 10 can reduce the inlet end 30 from a first diameter 36 to a second diameter 38 (FIG. 6) upon experiencing higher pressure flow. The reduction in diameter of the inlet end 30 will cause a pressure drop through the self-regulating pressure throttle 10 to accommodate for the increase in pressure. The reduction in diameter of the inlet end 30 from the first diameter 36 to the second diameter 38 results in less fluid able to pass through the throttle body 12. In this regard, the resulting fluid pressure exiting the throttle body 12 through the outlet end 32 is regulated back to (or substantially back to) its original magnitude upstream of the throttle body 12.

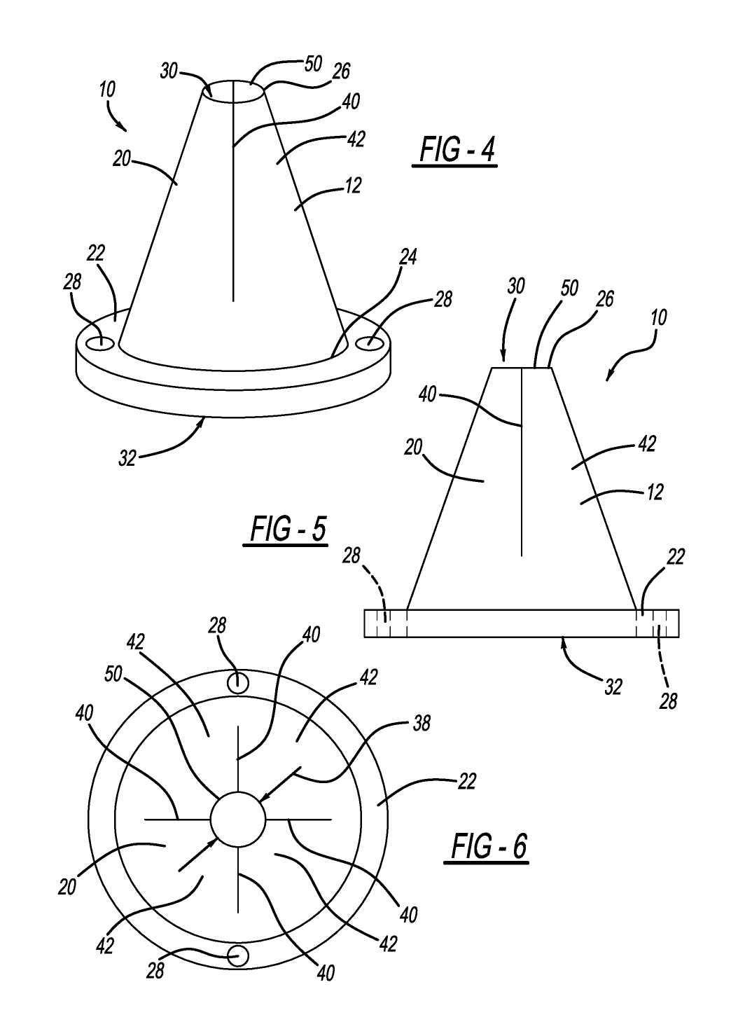

Additional features of the self-regulating pressure throttle 10 will now be described. The throttle body 12 can define slots 40 therein. The slots 40 can allow for the cone portion 20 of the throttle body 12 to flex inward. Explained further, the cone portion 20 of the throttle body 12 can include a series of segments 42 separated by the slots 40. At high pressure flow, the slots 40 (four shown in the examples provided however additional or fewer slots 40 may be incorporated) allow the throttle body 12 to flex thus allowing the segments 42 to move closer together from a first position (FIGS. 1-3) to a second position (FIGS. 4-6) reducing the size of a nozzle orifice 50 defined at the inlet end 30. The self-regulating pressure throttle 10 can be formed of a rigid material such as metal.

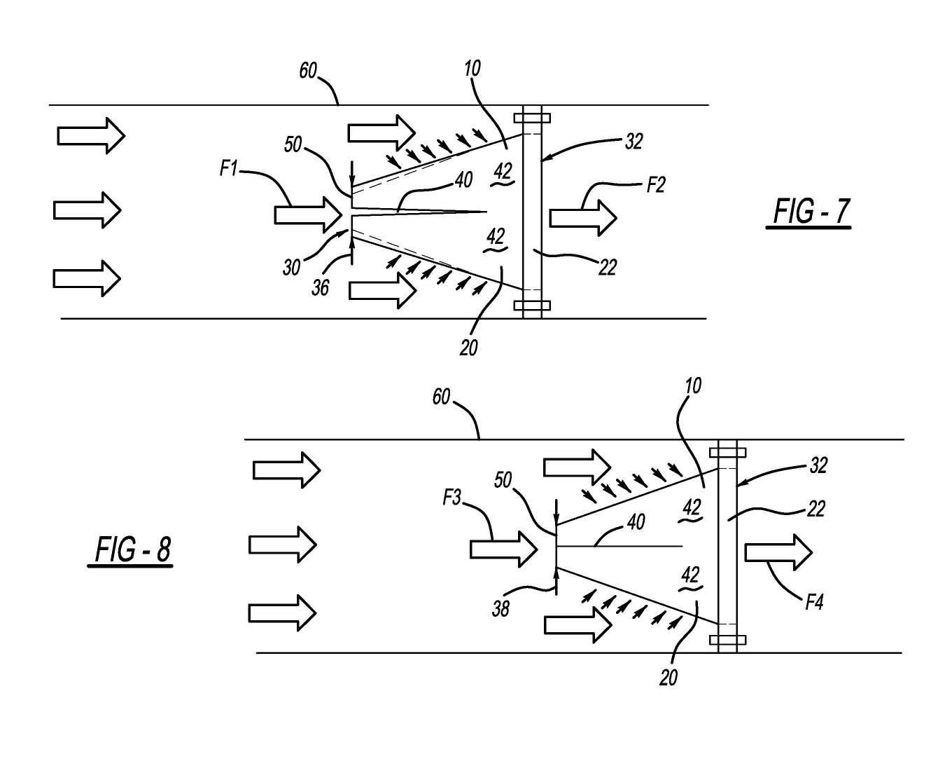

Turning now to FIGS. 7 and 8, operation of the self-regulating pressure throttle 10 will be described. FIG. 7 is a side view of the self-regulating pressure throttle 10 shown disposed in a fluid conduit 60 and in the first low pressure flow position. In the first low pressure flow position, the inlet end 30 of the self-regulating pressure throttle 10 has the first diameter 36. With a low pressure flow of fluid F1, the segments 42 of the cone portion 20 do not flex inward. Therefore, the nozzle orifice 50 maintains a maximum orifice diameter allowing maximum flow through the self-regulating pressure throttle 10 to the outlet end 32. A pressure flow of fluid F2 is represented downstream of the self-regulating pressure throttle 10. The fluid F2 can have a minimal pressure change from F1.

FIG. 8 illustrates the self-regulating pressure throttle 10 shown disposed in the fluid conduit 60 and in the second high pressure flow position. In the second high pressure flow position, the inlet end 30 of the self-regulating pressure throttle 10 has the second diameter 38. With a high pressure flow of fluid F3, the segments 42 of the cone portion 20 flex inward. Therefore, the nozzle orifice 50 reduces causing a pressure drop to accommodate for increase in pressure. A pressure flow of fluid F4 is represented downstream of the self-regulating pressure throttle 10. The pressure of flow of fluid F4 can be substantially similar to the pressure of fluid F2. In other words, the self-regulating pressure throttle 10 can regulate the flow of fluid to obtain equivalent or substantially equivalent flow F2, F4 regardless of the pressure F1 and F3 experienced upstream of the self-regulating pressure throttle 10. It will be appreciated that the nozzle orifice 50 can achieve incremental positions between what is shown in FIGS. 7 and 8 to accommodate flows having pressures between what is shown in FIGS. 7 and 8.

While the cone portion 20 is illustrated as having segments 42 that collapse toward each other at the slots 40, other configurations are contemplated. For example, the segments 42 can be arranged to collapse in an overlapping fashion to achieve a reduction in diameter of the nozzle orifice 50.

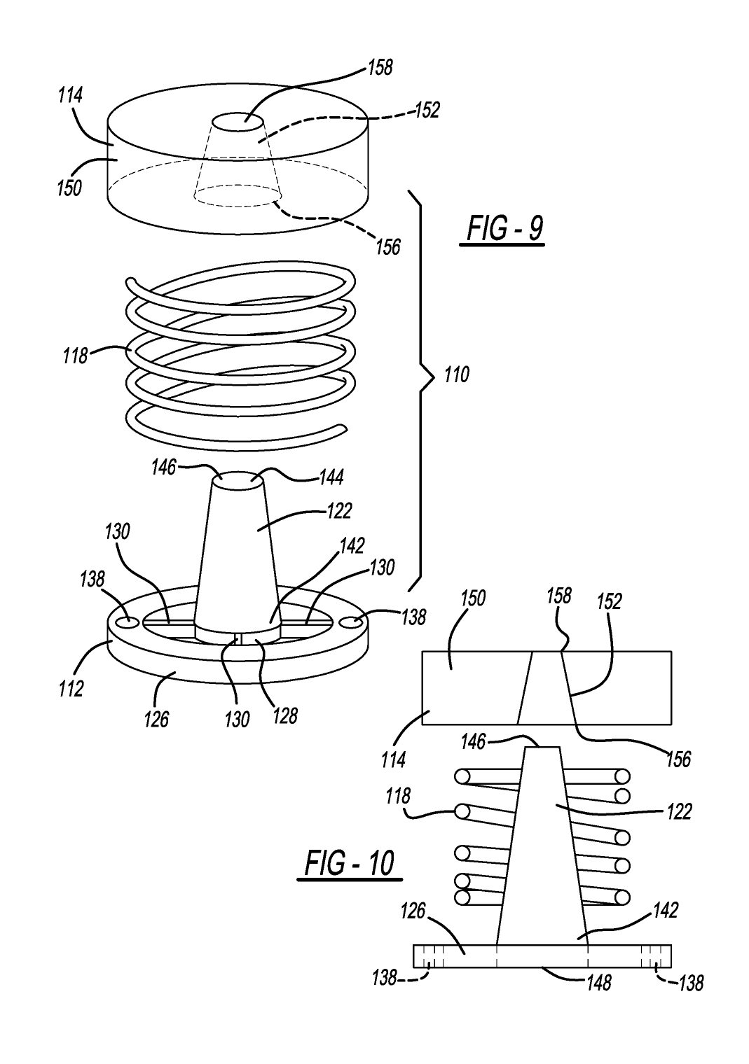

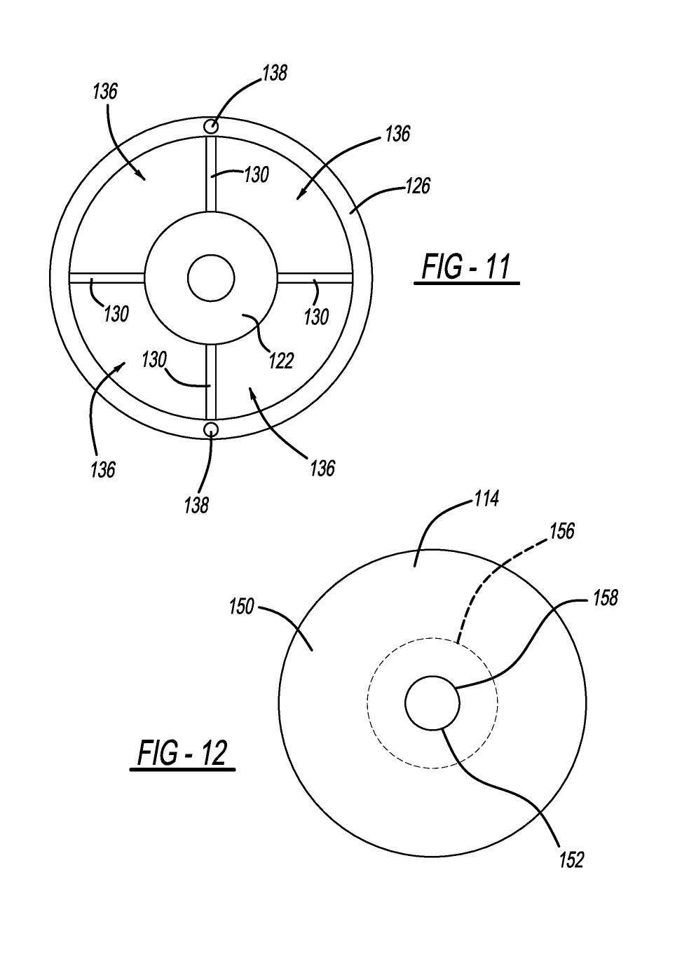

With reference now to FIGS. 9-14, a self-regulating pressure throttle constructed in accordance to another example of the present disclosure is shown and generally identified at reference numeral 110. The self-regulating pressure throttle 110 can include a guide cone 112, a pressure block 114 and a biasing member 118. The guide cone 112 can generally include a base portion 120 and a cone portion 122. The base portion 120 includes a ring 126 that is offset from a central portion 128 by a series of arms 130. The ring 126, central portion 128 and the arms 130 cooperate to define a series of openings 136 (FIG. 11). A series of apertures 138 can be formed around the ring 126. The apertures 138 can be used to attach the guide cone 112 of the self-regulating pressure throttle 110 to another component. The guide cone 112 can taper away from the central portion 128 of the base portion 120 from a first end 142 to a second end 144. The guide cone 112 can define an inlet end or inlet 146 and an outlet end or outlet 148.

The pressure block 114 will now be described in greater detail. The pressure block 114 can include a block body 150 that defines a block opening 152. The block opening 152 can taper from a first (outlet) end 156 to a second (inlet) end 158. The block opening 152 can have a geometry complementary to the cone portion 122 of the guide cone 112 (see FIG. 14). As will be described more fully herein, the pressure block 114 can move relative to the guide cone 112 to reduce the area of fluid allowed to flow past the self-regulating pressure throttle 110.

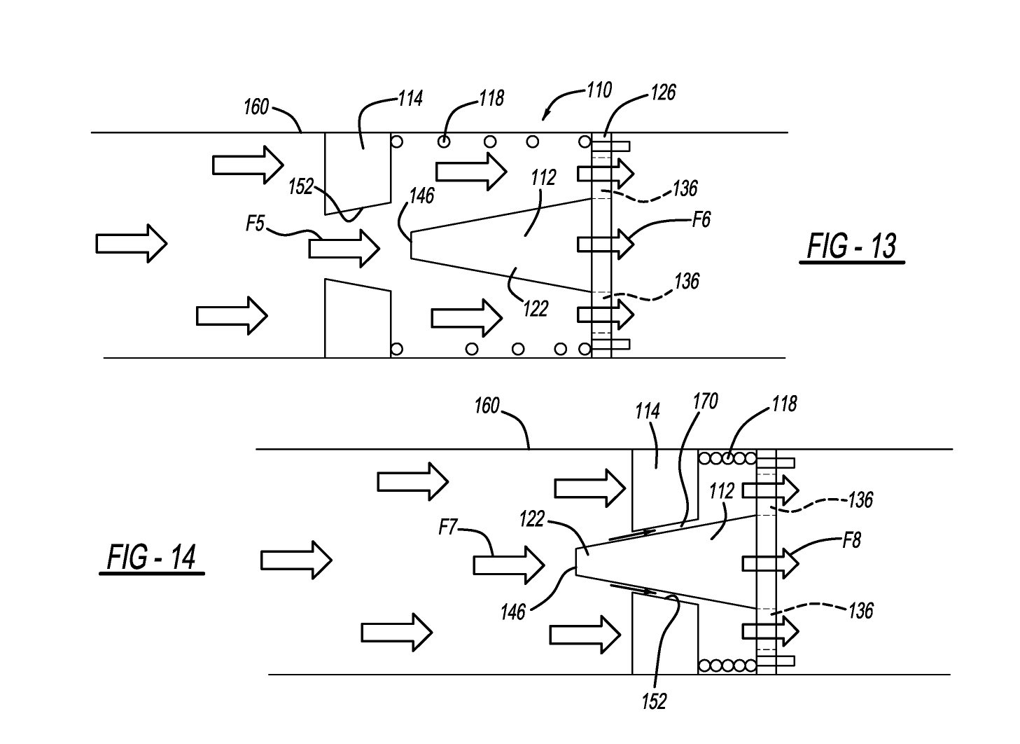

Turning now to FIGS. 13 and 14, operation of the self-regulating pressure throttle 110 will be described. FIG. 13 is a side view of the self-regulating pressure throttle 110 shown disposed in a fluid conduit 160 and in a first low pressure flow position. In the first low pressure flow position, the pressure block 114 does not compress the biasing member 118 since the forces acting on it are low. In this regard, the fluid pressure F5 is low and the fluid pressure F5 is substantially unchanged. The fluid pressure F5 will continue to pass through the inlet 146 and the openings 136 of the guide cone 112 and have a fluid pressure F6 downstream of the self-regulating pressure throttle 110. The fluid pressure F6 can have a minimal pressure change from F5.

FIG. 14 illustrates the self-regulating pressure throttle 110 shown disposed in the fluid conduit 160 and in a second high pressure flow position. In the second high pressure flow position, the pressure applied to the pressure block 114 by the flow F7 of fluid is now able to overcome the force of the biasing member 118 and subsequently compresses the biasing member 118. The pressure block 114 is therefore allowed to move over the guide cone 112. Specifically, the opening 152 can be guided onto the cone portion 122 of the guide cone 112. As a result, a reduced area or annular gap 170 is formed between the cone portion 122 and the opening 152 reducing the amount of flow F8 going through the openings 136 of the guide cone 112 and through the opening 152 of the pressure block 114. The pressure of flow of fluid F8 can be substantially similar to the pressure of fluid F6. In other words, the self-regulating pressure throttle 110 can regulate the flow of fluid to obtain equivalent or substantially equivalent flow F6, F8 regardless of the pressure F5 and F7 experienced upstream of the self-regulating pressure throttle 110. The pressure desired can be adjusted by adjusting the geometry of the pressure block 114, the guide cone 112 and the force of the biasing member 118.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A self-regulating pressure throttle configured for use in a fluid conduit, the self-regulating pressure throttle comprising:
a throttle body having an inlet end and an outlet end, the throttle body including a cone portion and a rim portion, the cone portion tapering away from the rim portion from a first end to a second end, the second end having a nozzle orifice;
a series of segments formed on the cone portion; and
wherein the series of segments are configured to move between (i) a first position wherein the nozzle orifice has a first diameter and (ii) a second position wherein the nozzle orifice has a second diameter, the second diameter being smaller than the first diameter, the series of segments configured to move from the first position to the second position upon an increased pressure flow of fluid at the inlet end.

2. The self-regulating pressure throttle of claim 1 wherein the series of segments are configured to flex inwardly from the first position to the second position.

3. The self-regulating pressure throttle of claim 2 wherein the cone portion defines a series of slots therein, wherein the series of segments are formed between adjacent slots of the series of slots.

4. The self-regulating pressure throttle of claim 3 wherein the cone portion includes four segments and four slots.

5. The self-regulating pressure throttle of claim 1 wherein the throttle body is formed of metal.

6. The self-regulating pressure throttle of claim 1 wherein the rim portion defines a series of apertures therein.

7. The self-regulating pressure throttle of claim 1 wherein movement of the nozzle orifice from the first diameter to the second diameter causes a pressure drop of fluid passing through the throttle body to accommodate for an increase of pressure flow of fluid at the inlet end.

8. A self-regulating pressure throttle configured for use in a fluid conduit, the self-regulating pressure throttle comprising:
a throttle body having an inlet end and an outlet end;
a cone portion formed on the throttle body and that that tapers away from the rim portion from a first end to a second end, the second end having a nozzle orifice;
a series of segments formed on the cone portion; and
wherein the series of segments are configured to flex inwardly between (i) a first position wherein the nozzle orifice has a first diameter and (ii) a second position wherein the nozzle orifice has a second diameter, the second diameter being smaller than the first diameter, the series of segments configured to move from the first position to the second position upon an increased pressure flow of fluid at the inlet end.

9. The self-regulating pressure throttle of claim 8 wherein the cone portion defines a series of slots therein, wherein the series of segments are formed between adjacent slots of the series of slots.

10. The self-regulating pressure throttle of claim 9 wherein the cone portion includes four segments and four slots.

11. The self-regulating pressure throttle of claim 8 wherein the throttle body is formed of metal.

12. The self-regulating pressure throttle of claim 8 wherein the rim portion defines a series of apertures therein.

13. The self-regulating pressure throttle of claim 8 wherein movement of the nozzle orifice from the first diameter to the second diameter causes a pressure drop of fluid passing through the throttle body to accommodate for an increase of pressure flow of fluid at the inlet end.

14. A self-regulating pressure throttle configured for use in a fluid conduit, the self-regulating pressure throttle comprising:
a guide cone having an inlet end and an outlet end, the guide cone including a base portion and a cone portion, the base portion having a ring that is offset from a central portion by a series of arms, the base portion defining a series of openings, the cone portion tapering away from the base portion to the inlet end; and
a pressure block having a block body that defines a block opening;
wherein the pressure block is configured to move relative to the guide cone between (i) a first position wherein fluid flows through the block opening and through the guide cone and (i) a second position wherein the guide cone locates into the block opening, wherein in the second position, an annular gap is formed between the cone portion and the opening of the pressure block reducing an amount of flow passing through the series of openings in the base portion and the opening of the pressure block.

15. The self-regulating pressure throttle of claim 14, further comprising a biasing member disposed between the guide cone and the pressure block, the biasing member biasing the pressure block to the first position.

16. The self-regulating pressure throttle of claim 14 wherein the series of openings are defined by the ring, central portion and the series of arms.

17. The self-regulating pressure throttle of claim 14 wherein the ring of the base portion defines a series of apertures therein.

18. The self-regulating pressure throttle of claim 14 wherein the block opening tapers from a first end to a second end.

19. The self-regulating pressure throttle of claim 14 wherein the biasing member is compressed when the pressure block is in the second position.

20. The self-regulating pressure throttle of claim 14 wherein the pressure block is configured to move relative to the guide cone to reduce an area of fluid allowed to flow past the self-regulating pressure throttle.
